(19) United States
(12) Patent Application Publication
(10) Pub. No.: US 2022/0219241 A1
(43) Pub. Date: Jul. 14, 2022

(54) POWDER FEED DEVICE FOR RAPID DEVELOPMENT AND ADDITIVE MANUFACTURING

(71) Applicants: The Regents of the University of California, Oakland, CA (US); Formalloy LLC, Spring Valley, CA (US)

(72) Inventors: Kenneth S. Vecchio, San Diego, CA (US); Jeffrey L. Riemann, Spring Valley, CA (US)

(21) Appl. No.: 17/441,180

(22) PCT Filed: Mar. 19, 2020
(86) PCT No.: PCT/US2020/023667

§ 371 Date: Sep. 20, 2021

Related U.S. Application Data
(60) Provisional application No. 62/821,842, filed on Mar. 21, 2019.

(51) Int. Cl. B22F 12/55; B33Y 40/00; B33Y 10/00; B33Y 30/00

(52) U.S. Cl. CPC B22F 12/55; B33Y 40/00; B22F 10/28; B33Y 30/00; B33Y 10/00

(57) ABSTRACT

A powder feed device for an additive manufacturing system that includes an energy source to transform powder in a melt pool. The device includes a plurality of powder vessels that are configured to mate with a powder feed intake that delivers powder to the additive manufacturing system. A vessel actuator can selectively mate ones of the plurality of powder vessels with the powder feed intake. Each of the plurality of powder vessels can include a carrier gas inlet.

### PRIORITY CLAIM AND REFERENCE TO RELATED APPLICATION

The application claims priority under 35 U.S.C. § 119 and all applicable statutes and treaties from prior U.S. provisional application Ser. No. 62/821,842, which was filed Mar. 21, 2019.

### FIELD

A field of the invention is additive manufacturing and powder delivery to an additive manufacturing device. An example application of the invention is to 3D metal deposition machines, such as Direct-Energy Deposition (DED) or Laser Metal Deposition (LMD) machines. The invention is generally applicable to any additive manufacturing system, including systems that use energy sources other than lasers, e.g., plasma, electron beams, torches, etc.

### BACKGROUND

Bulk metallic alloy development is traditionally a slow, time-consuming process, requiring sequential melting and casting of individual alloy compositions, followed by individual sequential characterization. With the advent of additive manufacturing (AM) technologies, in particular of the Directed-Energy Deposition (DED) type, opportunities arise to make metal alloy development faster and more efficient [i.e. high-throughput (HT)] as well as better-suited to AM technologies.

Powder-based DED systems, such as state-of-the-art Formalloy X-Series laser metal deposition system, utilize a powder feed intake that directs metal powder into a melt pool. The melt pool is typically created by a laser beam although other energy sources, such as electron beam and plasma energy sources, are feasible. Traditional powder feed systems consist of a feeding mechanism that is connected to a hopper filled with a homogenous powder. Various feeding mechanisms and hopper sizes and configurations exist, but the homogenous powder hopper concept is largely the same among different deposition systems.

DED systems are unique amongst other powder-based additive manufacturing (AM) technologies because the metal powder is directed into the melt pool precisely where it is needed, as opposed to conventional powder bed AM technologies, which consist of a large bed of powder that needs to be filled whenever a new build is to take place, regardless of the size and shape of the parts that are to be built within. The powder savings using DED systems compared with powder bed systems can be 1 or more orders of magnitude. FIG. 1 shows a powder feeder system with a hopper mounted above the powder feed intake. The powder feeder illustrated in FIG. 1 is an example of a powder feeder used in a typical DED system, although other similar feeder mechanisms are available. Generally, in conventional feeder mechanisms alloy powder is prepared and placed in the hopper. Under computer control of the DED system, the powder is moved into a horizontal disc intake feed and delivered to a deposition head. The deposition head directs the powder into the melt pool. The melt pool is created by a laser or other energy source. The composition of the deposited alloy is the same as the material residing in the hopper. The composition of powder mixture, and therefore the melt pool, is created prior to placing the power in the hopper by careful mixture of the powder. Changing to a new composition requires replacing the hopper.

The field of additive manufacturing (AM) has been growing extremely rapidly, and specifically metallic alloy applications of AM hold great promise to replace conventional fabrication methodologies in nearly every engineering field. Many conventional metallic alloy powders were developed before the AM technology was even conceived, and as such most of these materials are unsuited for this technology. Many materials producers, both powder, wire, and bulk alloy developers desire high throughput methods to experimentally synthesize and then characterize new alloy compositions.

The following published patent applications include information about DED systems that can be combined with a feeder device of the invention to provide a new DED system. Riemann US Published Application 20190047048, entitled Gradient material control and programming of additive manufacturing processes; Riemann US Published Application 20180072000 entitled Dynamic layer selection in additive manufacturing using sensor feedback.

### SUMMARY OF THE INVENTION

A preferred embodiment provides a powder feed device for an additive manufacturing system that includes an energy source to transform powder in a melt pool. The device includes a plurality of powder vessels that are configured to mate with a powder feed intake that delivers powder to the additive manufacturing system. A vessel actuator can selectively mate ones of the plurality of powder vessels with the powder feed intake. Each of the plurality of powder vessels preferably includes a carrier gas inlet.

A method for loading powder into an additive manufacturing system includes loading different powders into a plurality of powder vessels mounted on a powder vessel actuator. The vessel actuator is mechanically actuated to align a selected one of the plurality of powder vessels with a powder feed intake of an additive manufacturing system. The selected one of the plurality of powder vessels is mechanically mated with the powder feed intake. The selected one of the plurality of powder vessels is opened to allow powder to fall into the powder feed intake. Carrier gas is preferably flowed through the selected one of the plurality of powder vessels to equalize pressure in the selected one of the plurality of powder vessels and allow powder to more easily flow via gravity into the powder feed intake.

### BRIEF DESCRIPTION OF THE DRAWINGS

FIG. 1 (Prior Art) shows a conventional powder feeder system for a DED system with a hopper mounted above the powder feed intake;

FIG. 2 shows a preferred embodiment powder feeder device for an additive manufacturing system that includes multiple powder vessels;

FIG. 3 shows a preferred powder vessel and actuator for the device of FIG. 2;

FIG. 4 illustrates the preferred embodiment device of FIG. 2 with a cover added;

FIG. 5 is a top schematic view of the preferred embodiment device of FIG. 2;

FIG. 6 is an image of a laboratory embodiment consistent with FIG. 2;

FIG. 7 shows a preferred system with a plurality of devices of FIG. 2; and

FIG. 8A shows a preferred embodiment with a vacuum for the device of FIG. 2; FIG. 8B shows another preferred embodiment with a vaccum for the device of FIG. 2.

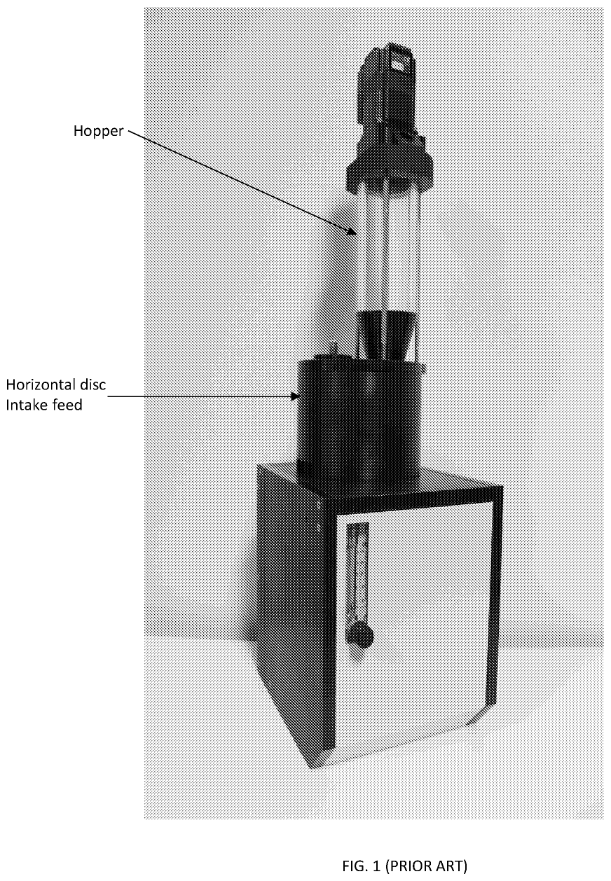

### DETAILED DESCRIPTION OF THE PREFERRED EMBODIMENTS

Preferred embodiments include feeder devices and additive manufacturing systems with feeder devices. An important application of the invention is to the rapid development of alloy compositions. A system of the invention can greatly reduce the time needed to test different alloy compositions, while also increasing control of the testing. As such, the invention is an important tool for rapid development and testing of new alloys.

The invention provides a tool to accelerate the metallic alloy synthesis methods, employing a laser, electron beam or other melting source, within an additive manufacturing machine. A powder feeder device of the invention can provide sequential feeding of different powder blends of specific powder mixtures, used to then form different alloy compositions so that high throughput bulk alloy synthesis can be achieved. A powder feeder device of the invention can also provide sequential and parallel feeding of different alloy components, so that alloy blends can rapidly form different alloy compositions, altering components and/or relative concentrations of the components.

A preferred powder feed device of the invention includes a plurality of powder vessels that are configured to mate with and seal to a powder feed intake of a DED system or other additive manufacturing system that includes an energy source to transform powder in a melt pool. A vessel actuator can change the powder vessel that mates with powder feed intake. When a particular powder vessel is mated, a sealed powder stopper unseals allowing powder to fall by force of gravity into the powder feed intake. The powder vessel preferably includes supply inlet for a carrier gas, e.g. argon gas, that can equalize the pressure in the powder feeder once the powder vessel is installed into the powder intake. Equalizing the pressure can allow powder to more easily fall via the force of gravity into the powder feed intake. A preferred device includes a vacuum for cleaning the powder feed intake. As an alternative or in addition, the powder vessels can include mechanical powder actuator to assist powder ejection from the powder vessel by agitation, or pressure differences. As another alternative, a vacuum can be applied to assist powder ejection by drawing powder out of the powder vessel. The powder feed device is controlled by a controller in coordination with the DED system, such that the system causes one or more powder vessels to supply a desired powder composition for the melt operation. The controller may be in the DED system, or may be a stand-alone controller that communicates with the DED system. A feeder of the invention can include plurality of vessel actuators, at least one controlling a plurality of powder vessels. In this way, more than one powder vessel can be brought to the powder feed intake at the same time for parallel loading of powder from multiple powder vessels.

A preferred operational method fills each powder vessel with a different metal alloy composition and then deposits those alloys via the DED system as quickly and efficiently as possible in order to analyze the specific material properties of each individual alloy. Conversely, traditional powder feed systems would require feeder disassembly, cleanout and reassembly and changing the hopper for each individual powder to be deposited or utilization of numerous dedicated powder feeder systems to achieve the same task. Thus, the time and equipment savings of the invention are at least one order of magnitude, especially as the number of alloys and powder vessels increases. In another method, the powder vessels include alloy components, and the powders from multiple powder vessels are combined between the DED feed intake and deposition head to form a desired alloy composition. With multiple powder vessels on multiple actuators, many combinations of alloy compositions can be quickly tested.

Preferred embodiments are illustrated with respect to an additive manufacturing system having a horizontal disc powder intake mechanism, such as used in the state-of-the art Formalloy X-Series laser metal deposition system. However, the powder delivery device of the invention can be applied to systems having other types of powder intake mechanisms, including vertical disks (similar to a water wheel), screws (like an auger) or vibratory (angled vibrating plates). Artisans will appreciate that systems of the invention can be applied these and other styles of powder intake mechanisms.

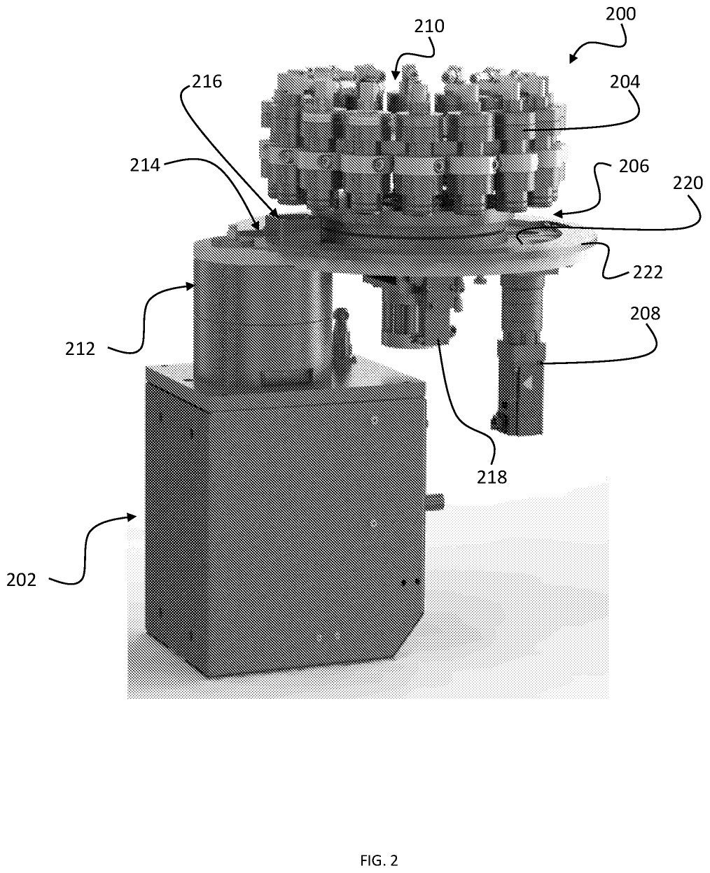

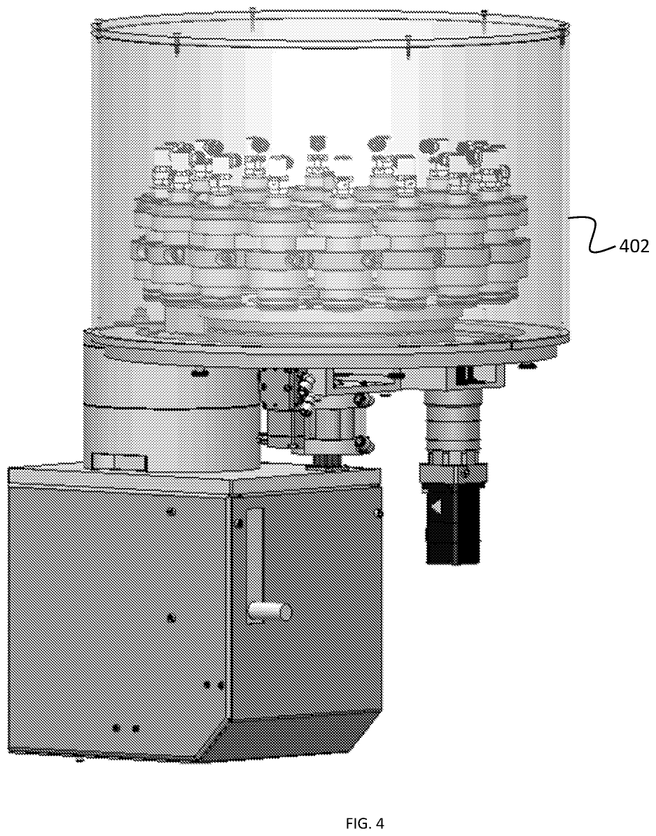

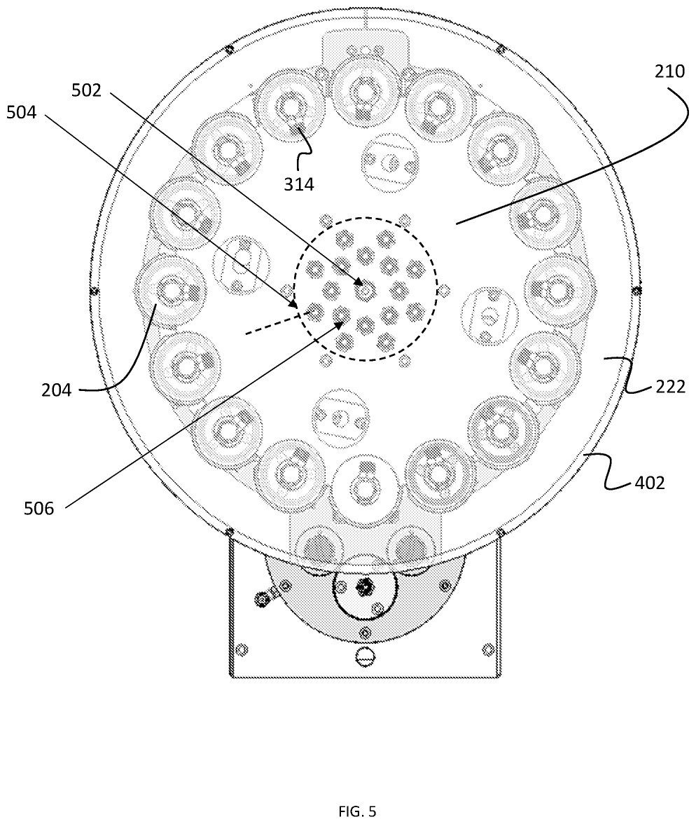

FIG. 2 illustrates a preferred feeder device 200 with a horizonal disk powder feed 202 that included an outlet 202 that can be attached to a DED system. A plurality of powder vessels 204 is mounted on a circular vessel actuator 206. The vessel actuator 206 includes rotational and vertical movement drives. An indexing drive 208 drives rotation of the carousel 210 (see also FIG. 4) around which the powder vessels 204 are attached. The rotational movement allows any one of the powder vessels 204 to be selectively aligned with a powder feeder 212 of the DED system 202 at a powder feed intake 214 via a powder vessel outlet 216 that is part of the carousel 210. The indexing drive 208 under control of a controller rotates a selected powder vessel 204 into alignment with the powder vessel outlet 216 and the powder feed intake 214 to mate with the feed intake. A load/unload drive 218 provides vertical movement to lower the carousel 210 when a selected powder vessel 204 has been positioned to mate with the powder feed intake 214 through the powder vessel outlet 216. The load/unload drive 218 is a pneumatic drive in preferred embodiments, but can also be implemented by a motor, for example.

In the example embodiment of FIG. 2, the indexing drive 208 turns a disc 220 inside a circular frame 222. The speed of the disc dictates the mass feedrate (e.g., grams/minute) of the powder exiting the feeder. The carrier gas pressurizes the selected powder vessel 204 and powder feeder and exits the feeder outlet. When positioned, the load/unload drive 218 lowers the carousel 210 to mate with the powder feed intake 214 through the powder vessel outlet 216. Carrier gas preferably equalizes pressure to allow easier falling of the powder out of the selected powder vessels 204 and to the deposition head (not pictured) of the DED system. The deposition head directs the powder into the melt pool. The carrier gas also dictates how fast the powder is transported through the lines. After the transfer of the powder, the load/unload drive 218 raises the carousel 210. The indexing drive 208 and the load/unload drive can be combined, both center-mounted, and in this way the same actuator rotates the carousel 210 and moves the powder vessel upward to unload it from the feeder inlet.

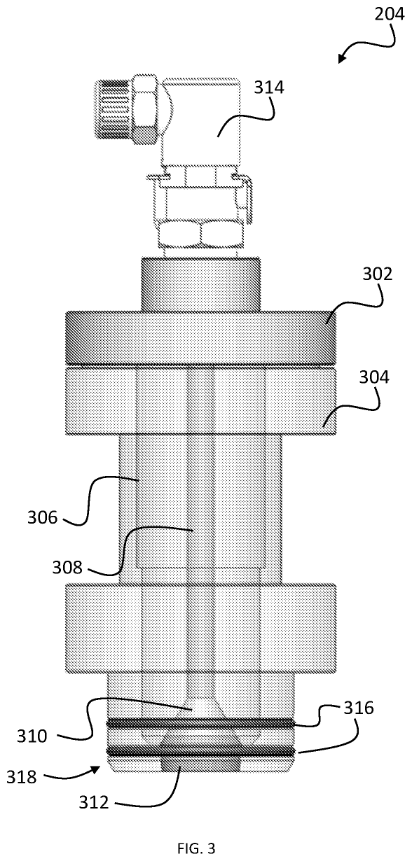

FIG. 3 shows a preferred powder vessel 204. A vessel lid 302 is removable, e.g., by threads, to add powder and attaches to a vessel body 304 that defines an internal volume 306 for holding powder. A stopper in the form of plunger 308 includes a shaped head 310 that closes an outlet 312 from the vessel body 304 to keep powder inside the internal volume 306 when not in use. Upon insertion to mate with the powder feed 212, a pin or other feature pushes the plunger 308 upward and allows powder to flow out of the internal volume and into the powder feed intake 214 of the DED system. Carrier gas that enters the powder vessel 204 through a carrier gas supply inlet 314 can equalize the pressure in the powder vessel 204 to allow the powder to fall more easily via the force of gravity into the powder feed intake 214. Seals 316 on the bottom of the vessel body 304 mate and preferably seal with the powder feed intake 214, either directly or through an intermediate structure such as the powder vessel outlet 216 on the carousel. Preferably, the seals 316 and bottom of the vessel body 304 mate directly with the powder feed intake 214. The vessel body 304 in the region of the seals includes a shaped portion 318 with a taper that helps to seat and engage the seals 216, and has a complementary shape to mate with the powder feed intake 214.

There are numerous mechanisms that can be used to mate the powder vessel 204 with the powder feed intake 214. For example, the powder feed intake 214 can include a spring-loaded valve that opens into the internal volume 306 as the powder vessel 204 mates with the feed intake 214, and the seals 316 mate as the powder vessel is moved into position by the load/unload drive 218. Preferably, powder carrier gas flow through the carrier gas supply inlet 314 gas equalizes pressure in the vessel to allow powder to enter the disc drive of the powder feeder from powder feed intake 214 of the DED system.

In preferred embodiments, the powder vessel 204 is a sealed vessel, such that when the powder vessel is mated to the powder feed intake 214 and pressurized through carrier gas introduced via the gas supply inlet, a gas flow path into or out of the feed intake is established and no or substantially no gas or powder escapes at the mating location. The system procedures can also include a powder cleaning of the powder feed intake 214. This can include an extended or increased carrier gas flow to move powder through after the melt or a vacuum evacuation to clean the powder feed intake 214 prior to a next powder delivery.

FIG. 4 shows the FIG. 2 device 200 with a transparent cover 402 attached to the frame 222. The cover provides a protection barrier to a human operator of the device. FIG. 5 shows a partial top schematic of the device 200. A central carrier gas supply 502 is in the carousel 210 and distributes carrier gas via a manifold 504 having a connection 506 for each of the powder vessels 204. Hose or pipes between connections 506 of the manifold 504 and the carrier gas supply inlets 314 of the powder vessels 204 are omitted for clarity of illustration.

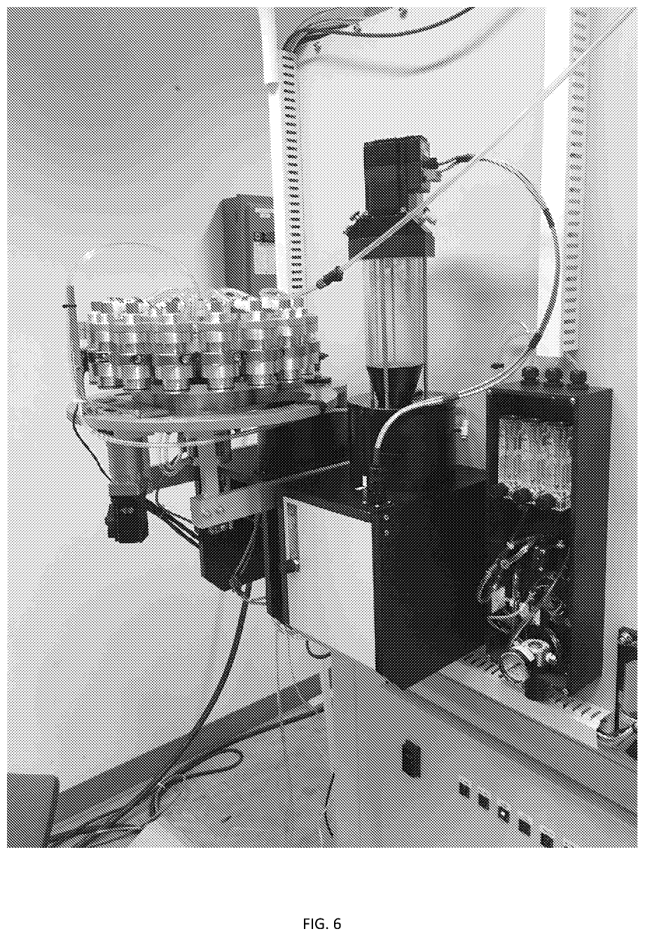

In the example system of FIGS. 2-5, 16 powder vessels are utilized but the quantity of powder vessels can be increased or decreased depending on the application requirements. The powder vessels in an example experimental revolving mechanism (pictured in FIG. 6) constructed in accordance with FIGS. 2-5 are relatively small (less than 50 mL) compared to traditional powder vessels that are typically 0.5 to 3 L. The small powder vessels are ideal for material development applications since only a small amount of each alloy is required to deposit a sample and analyze the material properties. Therefore, preferred embodiments of the present invention also can save substantial space, again at least one order of magnitude. Artisans will appreciate that there are different ways to mate the powder vessels with the feed intake. The actuator need not be circular, for example, the powder vessels could be arranged in a line or a square and the motion changed accordingly. In addition, the powder vessels can be moved individually up and down, instead of with all vessels. Alternatively, the feed intake can be moved up to meet a vessel.

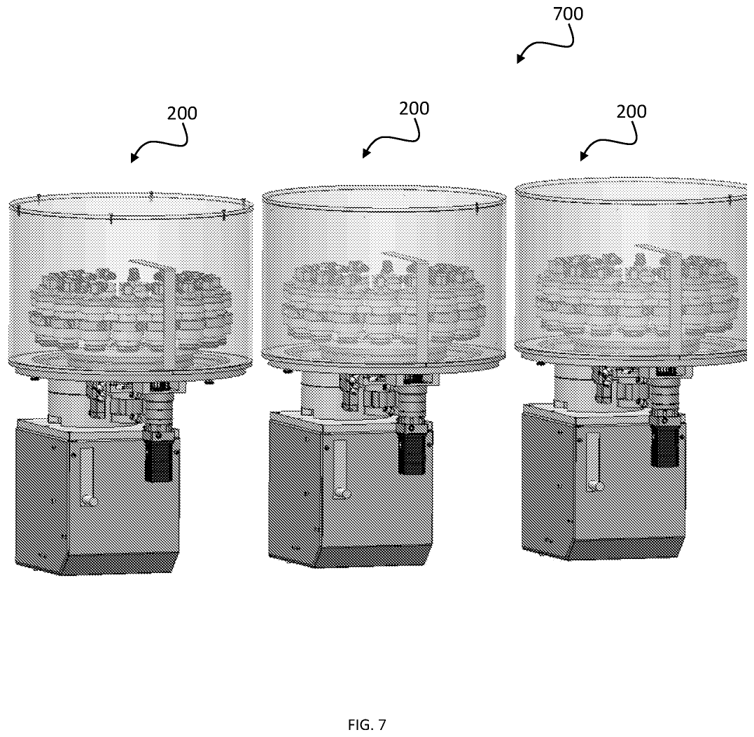

Generally, a high-throughput alloy development DED powder feed device includes a plurality of powder vessels incorporated into a single feeder system and the powder vessels can be mated with the feed intake. The powder vessels are installed on a feeder device that individually mates powder vessels to the feed intake. In a preferred method, an individual powder vessel from the series of vessels is inserted into the DED system powder intake. As another example, a system 700 in FIG. 7 includes a plurality of the FIG. 2 devices 200 such that multiple powder vessels from different devices 204 can be mated into multiple powder feed intakes of a DED system at the same time in parallel. Powder from the inserted powder vessel(s) is transported into the DED powder intakes via the powder feeder devices 200. The powder feeder devices 200 can deliver powder in parallel to the deposition head and the deposition head directs the powder into the melt pool.

The system 700 can be controlled to simultaneously interface one powder vessel 204 from each of the three feeder devices 200 to a DED system. The DED system includes three powder feed intakes 214. An alternative would have an additional mixer prior to a single feed intake on the DED system. In that instance, the parallel powder feed devices mate with an intake of the mixer, which then mates with an intake of the DED system.

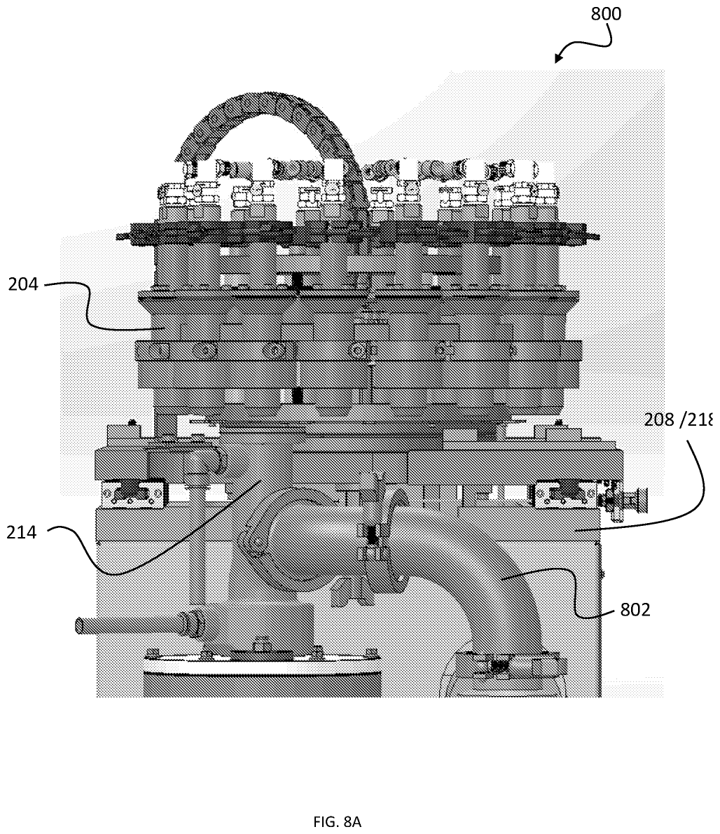

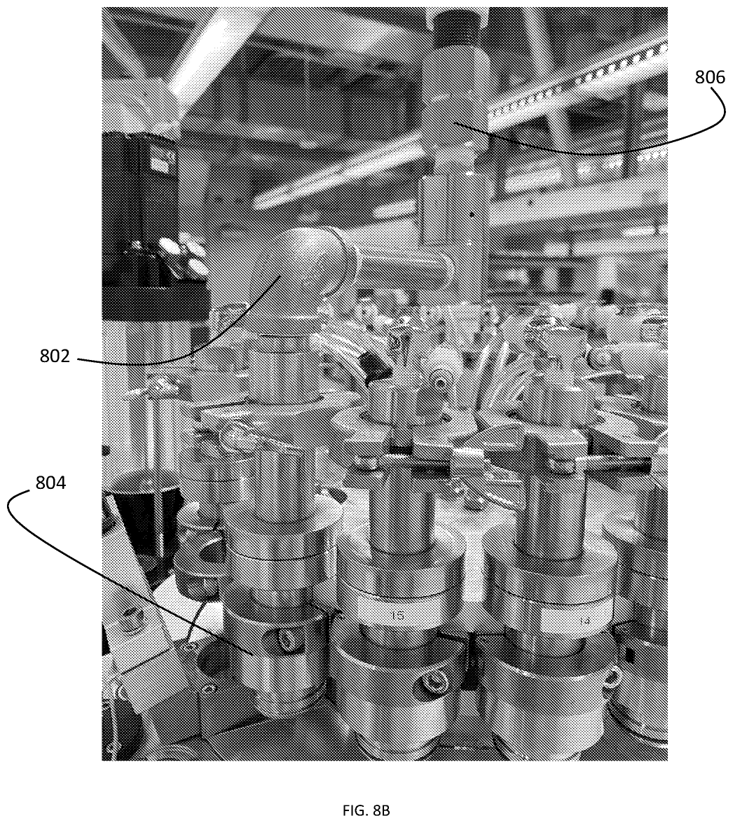

FIG. 8A illustrates a preferred feeder device 800 generally consistent with the device 200. The device 800 includes a housing for the indexing drive 208 and the load/unload drive 218, which are not separately seen in FIG. 8A. In addition, a vacuum line 802 is connected to the powder feed intake 214. When changing from one powder vessel 204 to another, in order to reduce contamination between changes, the vacuum line 802 is activated to remove powder from the powder feed intake.

In FIG. 8A, the vacuum line 802 is implemented as a T-joint with the powder feed intake 204. After powder from a first vessel has been passed through the feeder the vacuum turns on and sucks out the remaining powder in the intake area. After the vacuum cycle is complete the first vessel is moved away from the intake and a second vessel is moved into the intake. The powder from the second vessel feeds into the intake and passed through the feeder. Then the process is repeated.

A vacuum line can also be implemented as an independent mechanism from the powder feed intake, as shown in FIG. 8B. One of the vessels does not hold powder, but is used as a vacuum vessel 804 and is connected to the vacuum line. A rotating union 806 permits the vacuum line 802 to rotate with the carousel. After powder from a first powder vessel has been passed through the feeder, the first vessel is moved away from the intake and the vacuum vessel 804 is moved into the powder feed intake. The vacuum turns on and sucks out the remaining powder in the powder intake area. After the vacuum cycle is complete. the vacuum line 802 is moved away from the powder feed intake and a different selected powder vessel is moved into the powder feed intake. The powder from the second powder vessel feeds into the intake and passes through the feeder. Then the process is repeated.

When performing the vacuum process, the effectiveness of the vacuum can be enhanced by directing pressurized air or gas into the powder feed intake 214. The pressurized gas knocks loose powder that may have become stuck to powder feed intake 214. Pressurized gas is useful for certain powders that have a tendency to stick to surfaces, but not all powders will stick and use of pressurized gas is preferably omitted for such powders to speed powder selection and changing.

Control of the powder feeder devices of the invention can be through the system of the additive manufacturing system or can be implanted independently as a stand-alone controller for the present powder feed device. Generally, the controller performs the following functions: 1) selects which of the plurality of powder vessels is installed in the powder feeder intake, 2) mates with a selected powder vessel; 3) controls carrier flow to assist flow of powder from a selected vessel; and 4) controls vacuum cycle turn on or off When implemented independently, the DED system controller simply provides start and stop signals to the independent controller, thus allowing the multi-powder vessel system to be integrated with existing machines and equipment.

Preferred embodiments of the invention can reduce the alloy development timeline by an order of magnitude or more. The invention enables a paradigm change in alloy development methodologies.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A powder feed device for an additive manufacturing system that includes an energy source to transform powder in a melt pool, the device comprising a plurality of powder vessels that are configured to mate with a powder feed intake that delivers powder to the additive manufacturing system, and a vessel actuator for selectively mating ones of the plurality of powder vessels with the powder feed intake.

2. The device of claim 1, wherein the vessel actuator moves to align a vessel with the powder feed intake, lowers the vessel to mate the vessel with the powder feed intake, and raises the vessel to decouple the vessel.

3. The device of claim 1, comprising a vacuum to remove powder from the powder feed intake.

4. The device of claim 3, wherein the vacuum comprises a vacuum line connected to the powder feed intake.

5. The device of claim 4, wherein the vacuum comprises a vaccum line arranged in the plurality of powder vessels to selectively mate with the powder feed intake.

6. The device of claim 1, wherein the vessel actuator comprises a carousel with the plurality of vessels mounted on the carousel, further comprising a drive to raise and lower the carousel and a drive to rotate the carousel.

7. The device of claim 1, wherein the drive to raise and lower the carousel comprises a pneumatic drive.

8. The device of any of claim 1, wherein the vessel actuator comprises one drive that provides selection and another drive that provides mating of the ones of the plurality of powder vessels.

9. The device of claim 1, wherein each of the plurality of powder vessels comprises a vessel body with an internal volume that holds powder, a carrier gas supply inlet, a powder outlet and a closure for the powder outlet that is configured to open when mated with the powder feed intake.

10. The device of claim 9, wherein the closure comprises a plunger with a shaped head.

11. The device of claim 9, comprising a shaped portion that is configured to mate with the powder feed intake.

12. The device of claim 11, wherein the shaped portion is tapered.

13. The device of claim 11, comprising seals on the shaped portion.

14. An additive manufacturing system, the system including an energy source for melting powder and one or a plurality of the device of claim 1.

15. A method for loading powder into an additive manufacturing system, the method comprising:
loading different powders into a plurality of powder vessels mounted on a powder vessel actuator;
mechanically actuating the vessel actuator to align a selected one of the plurality of powder vessels with a powder feed intake of an additive manufacturing system;
mechanically mating the selected one of the plurality of powder vessels with the powder feed intake; and
opening the selected one of the plurality of powder vessels to allow powder to fall into the powder feed intake.

16. The method of claim 15, comprising flowing carrier gas through the selected one of the plurality of powder vessels to equalize pressure in the selected one of the plurality of powder.

17. The method of claim 15, further comprising mechanically unmating the selected one of the plurality of powder vessels and then applying vacuum to the powder feed intake to clean the powder feed intake.

18. The method of claim 17, further comprising repeating the mechanically actuating and mechanically mating to select another one of the plurality of powder vessels.

19. The method of any of claim 15, further comprising applying vacuum to clean the powder feed intake after the selected one of the pluarltiy of powder vessels has been mated with the powder feed intake.

20. The method of claim 15, wherein the mechanically mating comprises pneumatic driving.
